(19) United States
(12) Patent Application Publication
(10) Pub. No.: US 2018/0058461 A1
(43) Pub. Date: Mar. 1, 2018

(54) SYSTEM FOR PRODUCING ENERGY OR TORQUE

(71) Applicant: Valeo Systemes de Controle Moteur, Cergy Saint Christophe (FR)

(72) Inventor: Sébastien Potteau, Cergy Saint Christophe (FR)

(73) Assignee: Valeo Systemes de Controle Moteur, Cergy Saint Christophe (FR)

(21) Appl. No.: 15/559,289

(22) PCT Filed: Mar. 16, 2016
(86) PCT No.: PCT/FR2016/050585

§ 371 Date: Sep. 18, 2017

(30) Foreign Application Priority Data
Mar. 19, 2015 (FR) 1552255

(51) Int. Cl. F04D 27/00; F02C 6/12; F02C 7/143; F04D 25/06; F04D 29/58; H01M 8/10

(52) U.S. Cl. CPC F04D 27/005; F02C 6/12; F02C 7/143; F04D 17/10; F04D 29/5826; H01M 8/10; F05D 2220/40; F04D 25/06

(57) ABSTRACT

The invention relates to a system (100) for producing energy or torque, comprising: a generator designed so as to generate energy or torque from a gas introduced at an admission of the generator; at least two compressors (101, 102) for compressing the gas at the admission of the generator; and a pipeline system (103) in which the pipes (101a, 102a, 101b, 102b, Ce, Cs) are designed such that they can be opened or closed in order to selectively place said compressors (101, 102) in series or in parallel.

### TECHNICAL DOMAIN

The present invention relates to a system for producing energy or torque. In particular, the invention relates to a system for producing torque that includes a combustion engine and an energy production system including a fuel cell.

### TECHNOLOGICAL BACKGROUND

The use of a fuel cell is considered to be a viable solution for reducing the polluting gases emitted by vehicles. Typically, the fuel cell provides the electricity from reagents such as air and hydrogen. Such electricity production is advantageous in terms of pollution since same only emits water vapor. The electricity produced provides the vehicle with energy that can be used to drive the vehicle or to power the components of the vehicle. Using a compressor to increase the pressure of the reagents, in particular the air supplied to the fuel cell, helps to improve the efficiency of the fuel cell. However, using a compressor is costly in terms of energy.

Furthermore, it is known to use a supercharger at the air intake of a combustion engine to maintain the performance of the engine while reducing the cylinder capacity of the engine, a process known as “downsizing”. As with the fuel cell, using a compressor is costly in terms of energy.

A solution is therefore sought to reduce the cost related to the use of gas compression at the intake of a torque or energy generation system, such as a system including a combustion engine or a system including a fuel cell.

### SUMMARY OF THE INVENTION

The invention relates to a system for producing energy or torque including:
a generator designed to generate energy or torque from a gas fed into an intake of the generator,
at least two compressors for the gas at the intake of the generator,
a ducting system in which the ducts are designed to be opened or closed in order to selectively arrange said compressors in series or in parallel.

In particular, the production system is carried on board a vehicle, the generator being designed to generate torque to drive the vehicle, or electrical energy to drive the vehicle and/or to power the components carried on board the vehicle.

The efficiency of a compressor is a function of the operating conditions thereof, such as the ratio between the inlet pressure and the outlet pressure thereof, the air flow rate thereof and the rotational speed thereof. By using two or more compressors, each compressor can be used in the optimum efficiency region of the compressor. The ducting system enables the compressors to be joined in series or in parallel, enabling each compressor to operate in a favorable efficiency region in consideration of the operating conditions of the generator.

According to one embodiment:
the gas inlet of each compressor is linked to a respective first duct for bringing gas into said compressor, the first ducts being linked to a shared gas intake duct, at least one gas guiding device being designed to control the flow rate between the shared gas intake duct and at least one of the first ducts,
the gas outlet of each compressor is linked to a respective second duct for taking gas out of said compressor, the second ducts being linked to a shared gas outlet duct, at least one gas guiding device being designed to control the flow rate between at least one of the second ducts and the shared gas outlet duct.

In particular, the gas guiding device is a three-way valve.

According to one embodiment, a third duct links the gas outlet of one of the compressors to the gas inlet of the other compressor, a gas guiding device being arranged in said duct to prevent or enable the flow of gas in the third duct such as to selectively arrange the two compressors in series or otherwise.

According to a variant, the third duct includes a heat exchanger designed to cool the incoming gas in the compressor located downstream.

According to one embodiment, the ducting system is also designed to isolate at least one of the compressors such that said compressor does not receive any gas or does not emit any gas. This enables just one of the two compressors to be supplied. This helps to improve the low-load efficiency of a vehicle carrying the system.

According to one embodiment, the compressors are designed to operate alternately. Notably, when the production system is in operation, each compressor operates alternately for a period of time. One of the compressors is working during each period of time, i.e. compressing the gas at the intake of the generator, while the other generator is not supplying any gas to the intake to the intake of the generator, and in particular this generator is stopped or in standby. This prevents the bearings of the compressors from overheating. For example, the period of time is between 3 and 15 seconds, or exactly 15 seconds.

According to one embodiment, at least one of the compressors is driven by the exhaust gases supplied by the generator.

According to one embodiment, at least one of the compressors is driven by electrical energy. In particular, the electrical energy is supplied by an electrical energy storage device such as a battery, in particular a battery of the vehicle carrying the system. According to a variant, the compressor is driven by a switched-reluctance electric motor.

According to one embodiment, the generator is a combustion engine that delivers torque. In particular, this torque is designed to drive a movement of the vehicle carrying the system. For this purpose, the torque can be transmitted to one or more wheels of the vehicle.

According to one embodiment, the generator is a fuel cell that delivers electrical energy. In particular, this electrical energy is designed to drive an electric motor to move the vehicle carrying the system.

### DESCRIPTION OF THE FIGURES

Other objectives, characteristics and advantages of the invention can be better understood from and are set out more clearly in the description provided below with reference to the attached figures, which are provided as examples and in which:

FIG. 1 is a graph showing the efficiency of a compressor as a function of parameters of the compressor,

FIG. 2 is a diagram showing a parallel operating mode of a system according to the invention,

FIG. 3 is a diagram showing a serial operating mode of a system according to the invention,

FIG. 4 is a diagram showing an operating mode of a system according to the invention in which only one compressor is in operation,

FIGS. 5 and 6 respectively show operation in parallel and operation in series of a system in which one of the compressors is driven by a turbine,

FIG. 7 shows an serial operating mode of a system that includes a heat exchanger in the ducting system of same.

### DETAILED DESCRIPTION

In the remainder of the description, compressor shall refer to a gas compressor, in particular an air compressor, that is volumetric or otherwise, that is for example centrifugal or radial, compressing a gas in order to supercharge a torque generator such as a combustion engine or to compress the reagents supplying a fuel cell to generate electrical energy. According to one embodiment of the invention, the compressor is an air supercharger.

Henceforth, the system is described with a fuel cell, but the description would be similar with a combustion engine.

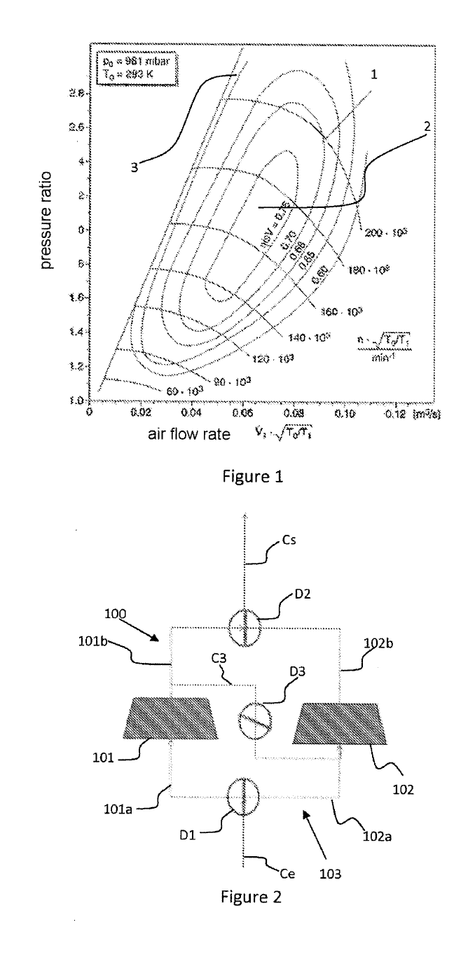

FIG. 1 shows the efficiency of a compressor as a function of the ratio of outlet pressure to inlet pressure on the Y-axis and the air flow rate (kg/s or m³/h or m³/s) on the X-axis. The lines 1 are velocity contours, in which the units are rotations/minute.

The optimum efficiency region 2 corresponds to efficiency greater than 75%. If a single compressor is used to compress the air supplied to the fuel cell, according to the operating conditions of the fuel cell, the compressor can be operated in a low-efficiency region, for example in region 3, which corresponds to efficiency below 30%.

An example system 100 according to the invention is shown in FIG. 2. The system 100 includes two compressors 101, 102 and a ducting system 103 that links the air intake to the inlets of the compressors 101, 102, the outlets of the compressors 101, 102 to the inlet of the fuel cell (not shown) and the outlet of a first compressor 101 to the inlet of a second compressor 102.

The first compressors 101, 102 are linked via the air inlet thereof to a respective first duct 101a, 102a for air intake. The first ducts 101a, 102a receive the intake air via a shared air intake duct Ce. Equally, the first compressors 101, 102 are linked via the air outlets of same to a respective second duct 101b, 102b for the air outlet to the fuel cell. The two ducts 101b, 102b supply the air to a shared air outlet duct Cs.

A third duct C3 links the air outlet of the first compressor 101 to the air inlet of the second compressor 102.

The gas guiding devices D1, D2, D3 enable the ducts of the ducting system 103 to be opened or closed to arrange the compressors 101, 102 in series or in parallel. A first gas guiding device D1 is arranged at the intersection of the first ducts 101a, 102a and of the inlet duct Ce to control the flow rate between the shared gas intake duct Ce and the first ducts 101a, 102a. A second gas guiding device D2 is placed at the intersection of the second ducts 101b, 102b and of the output duct Cs to control the flow rate between the second ducts 101b, 102b and the shared air outlet duct Cs. The first gas guiding device D1 and the second gas guiding device D2 can each be a three-way valve that enables the ducts to be brought into paired communication. A third gas guiding device D3 is arranged in the third duct C3 to prevent or enable the flow of air between the first compressor 101 and the second compressor 102.

In FIG. 2, the compressors 101, 102 operate in parallel. The first gas guiding device D1 keeps the first ducts 101a, 102a open to enable said ducts to receive the air ducted by the shared inlet duct Ce, and the second D2 gas guiding device D1 keeps the second ducts 101b, 102b open to enable said ducts to supply air to the shared outlet duct Cs. The third gas guiding device D3 closes the third duct D3 to prevent air being exchanged between the first compressor 101 and the second compressor 102. This parallel operating mode is particularly advantageous if the fuel cell is working at full load, for example at a load greater than 75%.

In a variant of the operating mode in FIG. 2, the compressors 101, 102 operate alternately. The first compressor 101 operates for a period of time, for example 15 seconds, while the other compressor 102 is stopped or in standby. During the subsequent period of time, the second compressor 102 is in operation, while the other compressor 101 is stopped or in standby. This alternating operation helps to share the heating related to operation of the compressor between the two compressors. This heating is in particular caused by the increase in temperature of the bearings of the compressor. While one of the compressors is compressing the air, the other compressor is not working, enabling same to be cooled. This is particularly advantageous if the two compressors 101, 102 are driven electrically.

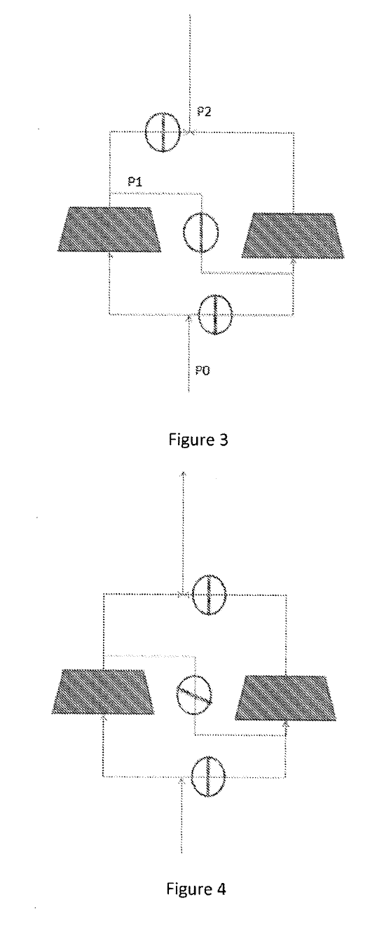

In FIG. 3, the compressors 101, 102 operate in series. The first gas guiding device D1 keeps the first duct 101a of the first compressor 101 open and closes the first duct 102a of the second compressor 102 such that the air ducted by the shared inlet duct Ce flows through the first compressor 101 only. The third gas guiding device D3 is opened to enable the air compressed by the first compressor 101 to enter the second compressor 102. The second gas guiding device D2 keeps the second duct 102b of the second compressor 102 open and closes the second duct 101b of the first compressor 101 such that the air supplied to the shared outlet duct Cs comes from the second compressor 102 only. This serial operating mode is particularly advantageous if the fuel cell is working at medium load, for example between 50% and 75%. For example, the pressure PO of the air ducted to the first compressor 101 is 1 bar, the output pressure P1 of the first compressor 101 is 1.5 bars and the output pressure P2 of the second compressor 102 is 2.25 bars.

In FIG. 4, only the first compressor 101 is in operation, the second compressor 102 being stopped or in standby. The gas guiding devices D1, D2, D3 respectively close the first duct 102a of the second compressor 102, the second duct 102b of the second compressor 102 and the third duct C3, thereby enabling the second compressor 102 to be isolated from the air flowing in the ducting system 103. This operating mode is particularly advantageous if the fuel cell is working at medium load, for example between 25% and 50%. In one variant, the second compressor 102 is in operation, while the first compressor 101 is stopped or in standby. The choice of one or other of the compressors 101, 102 may be determined by an overheating of the compressor, for example in relation to a previous activity of the compressor. Thus, for example, the compressor with the lowest temperature may be selected for this operating mode.

The compressors 101, 102 may be driven electrically or by the exhaust gases produced by the fuel cell. For example, the two compressors 101, 102 are driven electrically by an electric motor built into the compressor.

The electric motor of the electric compressor may be a synchronous AC or DC motor or any other electric motor suitable for driving the compressor. More specifically, the electric motor may be a switched reluctance motor (SRM).

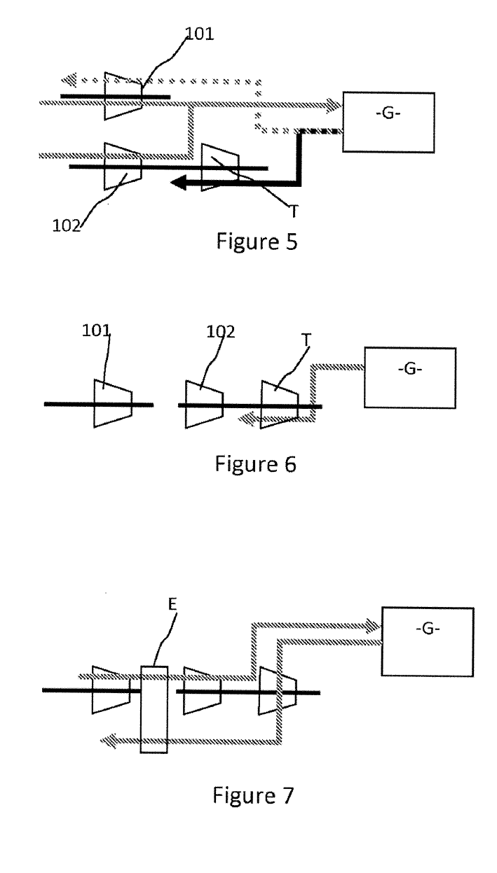

In the examples shown in FIGS. 5 and 6, the first compressor 101 is driven electrically and the second compressor 102 is driven by a turbine T that receives the exhaust gases produced by the fuel cell G. In FIG. 5, the compressors 101, 102 are in parallel. In FIG. 6, the compressors 101, 102 are in series.

The system 100 may include a heat exchanger E to cool the air delivered to the fuel cell, and for example the gases coming from the first mechanical compressor 101. This heat exchanger E is notably an exchanger known to the person skilled in the art as a charge air cooler. The heat exchanger E provides a heat exchange between the intake gases and the heat-transfer fluid of the heat exchanger E. At the outlet of the heat exchanger E, the gases are at a temperature close to the temperature of the heat-transfer fluid of the heat exchanger E.

In the example in FIG. 7, the heat exchanger E is on the third duct C3 to cool the air between the first compressor 101 and the second compressor 102 when same are arranged in series. The heat exchanger E can also cool the exhaust gases delivered by the fuel cell G, for example after these gases have driven the turbine T of the compressor 102.

FIGS. 2 to 7 have been described with a fuel cell. However, the fuel cell could be replaced by a combustion engine without substantially modifying the description. Furthermore, an intake gas other than air could be used as a function of the reagents used to operate the fuel cell.

The scope of the present invention is not limited to the details set out above and covers numerous other specific embodiments without leaving the scope of the invention. Consequently, the present embodiments should be understood to be examples that can be modified without thereby moving outside the scope defined by the claims.

1. A system for producing energy or torque, comprising:
a generator configured to generate energy or torque from a gas fed into an intake of the generator;
at least two compressors for the gas at the intake of the generator; and
a ducting system in which ducts are opened or closed to selectively arrange said compressors in series or in parallel.

2. The system as claimed in claim 1, wherein:
the gas inlet of each compressor is linked to a respective first duct for bringing gas into said compressor, the first ducts being linked to a shared gas intake duct, at least one gas guiding device being configured to control the flow rate between the shared gas intake duct and at least one of the first ducts,
the gas outlet of each compressor is linked to a respective second duct for taking gas out of said compressor, the second ducts being linked to a shared gas outlet duct, at least one gas guiding device being designed configured to control the flow rate between at least one of the second ducts and the shared gas outlet duct.

3. The system as claimed in claim 1, wherein a third duct links the gas outlet of one of the compressors to the gas inlet of the other compressor, a gas guiding device being arranged in said duct to prevent or enable the flow of gas in the third duct such as to selectively arrange the two compressors in series or otherwise.

4. The system as claimed in claim 3, wherein the third duct includes a heat exchanger designed configured to cool the incoming gas in the compressor located downstream.

5. The system as claimed in claim 1, wherein the ducting system is also designed to isolate at least one of the compressors such that said compressor does not receive or emit any gas.

6. The system as claimed in claim 1, wherein the compressors operate alternately.

7. The system as claimed in claim 1, in which at least one of the compressors is driven by the exhaust gases supplied by the generator.

8. The system as claimed in claim 1, wherein at least one of the compressors is driven by electrical energy.

9. The system as claimed in claim 1, wherein the generator is a combustion engine that delivers torque.

10. The system as claimed in claim 1 wherein the generator is a fuel cell that delivers electrical energy.
